(19) United States
(12) Patent Application Publication
(10) Pub. No.: US 2010/0220201 A1
(43) Pub. Date: Sep. 2, 2010

(54) DIGITAL IMAGE PROCESSING APPARATUS AND METHOD OF CONTROLLING THE SAME

(75) Inventor: Min-suk Hong, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/650,702

(22) Filed: Dec. 31, 2009

(30) Foreign Application Priority Data
Mar. 2, 2009 (KR) 10-2009-0017766

(51) Int. Cl. H04N 5/228

(52) U.S. Cl. 348/208.12; 348/E05.031

(57) ABSTRACT

Provided are a digital image processing apparatus having improved hand-shake compensation performance by measuring a distance between the digital image processing apparatus and a subject to be photographed and performing hand-shake compensation by reflecting the measured distance, and a method of controlling the digital image processing apparatus. The method of controlling the digital image processing apparatus includes measuring a subject distance corresponding to a distance between a body of the digital image processing apparatus and a subject to be photographed; setting a first tuning coefficient for tuning hand-shake compensation according to the subject distance; sensing hand-shake that causes the body to shake; and compensating for the hand-shake by incorporating the first tuning coefficient.

### CROSS-REFERENCE TO RELATED PATENT APPLICATION

This application claims the benefit of Korean Patent Application No. 10-2009-0017766, filed on Mar. 2, 2009, in the Korean Intellectual Property Office, the disclosure of which is incorporated herein in its entirety by reference.

### BACKGROUND

The present invention relates to a digital image processing apparatus and a method of controlling the same, and more particularly, to a digital image processing apparatus which controls the focus of an input image by auto focusing, detects hand-shake, and compensates for the detected hand-shake, and a method of controlling the digital image processing apparatus.

Typical examples of digital image processing apparatuses include devices that process images or use image recognition sensors, for example, digital cameras, personal digital assistants (PDAs), camera phones, personal computer (PC) cameras, etc.

Digital image processing apparatuses may process images received from an imaging device by using a digital signal processor (DSP), compress the processed images to generate image files, and store the image files in a memory.

The digital image processing apparatuses may also display on a display device, such as a liquid crystal display (LCD), images contained in image files received from the imaging device or stored in a storage medium.

The digital image processing apparatuses may include a hand-shake sensing unit and a hand-shake compensation unit in order to sense shaking of the digital image processing apparatus caused by a user's manipulations or the like and to compensate for the shaking of the body of the digital image processing apparatus. More specifically, the hand-shake sensing unit senses a shake of the body of the digital image processing apparatus caused by the user's manipulations, and the hand-shake compensation unit controls a lens unit, an image sensor, or the like according to the sensed shake, to compensate for the shake of the body of the digital image processing apparatus.

### SUMMARY

The present invention provides a digital image processing apparatus having improved hand-shake compensation performance by measuring a distance between the digital image processing apparatus and a subject to be photographed and performing hand-shake compensation by reflecting the measured distance, and a method of controlling the digital image processing apparatus.

According to an aspect of the present invention, there is provided a method of controlling a digital image processing apparatus, the method including measuring a subject distance corresponding to a distance between a body of the digital image processing apparatus and a subject to be photographed; setting a first tuning coefficient for tuning hand-shake compensation according to the subject distance; sensing hand-shake that causes the body of the digital image processing apparatus to shake; and compensating for the hand-shake by incorporating the first tuning coefficient.

The subject distance may be measured by automatic focusing control.

The measuring of the subject distance may include receiving input images at locations of a focusing lens obtained by moving the focusing lens at predetermined intervals; determining a location of the focusing lens, at which the clearest image from among the input images is received, to be a focus location; and measuring a distance corresponding to the focus location as the subject distance.

The first tuning coefficient may be set so that a compensation amount for compensating for the hand-shake increases in proportion to the subject distance.

The method may further include reading a current zoom magnification; and setting a second tuning coefficient for controlling hand-shake compensation according to the current zoom magnification.

In the compensating of the hand-shake, the hand-shake may be compensated for by incorporating the first and second tuning coefficients.

The second tuning coefficient may be set so that a compensation amount for compensating for the hand-shake increases in proportion to the zoom magnification.

According to another aspect of the present invention, there is provided a digital image processing apparatus including a distance measuring unit measuring a subject distance corresponding to a distance between the body of the digital image processing apparatus and a subject to be photographed; a hand-shake compensation unit compensating for hand-shake that causes the body to shake; and a control unit setting a first tuning coefficient for tuning hand-shake compensation according to the subject distance and controlling the hand-shake compensation unit to compensate for the hand-shake by incorporating the first tuning coefficient.

The distance measuring unit may measure the subject distance by automatic focusing control.

The distance measuring unit may include a focusing lens receiving input images at locations of the focusing lens obtained by moving the focusing lens at predetermined intervals; and a focusing driving unit driving the focusing lens to move.

The control unit may determine a location of the focusing lens at which the clearest image from among the input images is received, to be a focus location, and measure a distance corresponding to the focus location as the subject distance.

The first tuning coefficient may be set so that a compensation amount for compensating for the hand-shake increases in proportion to the subject distance.

The hand-shake compensation unit may include a hand-shake sensing unit sensing hand-shake that causes the body to shake; and a hand-shake compensation driving unit being driven in response to the sensed hand-shake and compensating for the hand-shake.

The digital image processing apparatus may further include a zoom control unit controlling a zoom magnification.

The control unit may set a second tuning coefficient for controlling hand-shake compensation according to the zoom magnification and controlling the hand-shake compensation unit to compensate for the hand-shake by incorporating the first and second tuning coefficients.

The second tuning coefficient may be set so that a compensation amount for compensating for the hand-shake increases in proportion to the zoom magnification.

In a digital image processing apparatus and a method of controlling the same according to the present invention, a distance between the digital image processing apparatus and a subject to be photographed is measured, and hand-shake compensation is performed by reflecting the measured distance, thereby improving hand-shake compensation performance.

### BRIEF DESCRIPTION OF THE DRAWINGS

The above and other features and advantages of the present invention will become more apparent by describing in detail exemplary embodiments thereof with reference to the attached drawings in which:

FIG. 1 is a rear view of a digital camera which is an example of a digital image processing apparatus according to the present invention;

FIG. 2 is a block diagram schematically illustrating a controlling apparatus that may be included in the digital camera of FIG. 1;

FIG. 3 is a block diagram schematically illustrating a digital image processing apparatus according to an embodiment of the present invention;

FIG. 4 is a flowchart of a method of controlling a digital image processing apparatus, according to an embodiment of the present invention; and

FIG. 5 is a flowchart of a method of controlling a digital image processing apparatus, according to another embodiment of the present invention.

### DETAILED DESCRIPTION OF THE EMBODIMENTS

Hereinafter, the present invention will be described in detail by explaining preferred embodiments of the invention with reference to the attached drawings. Like reference numerals in the drawings denote like elements.

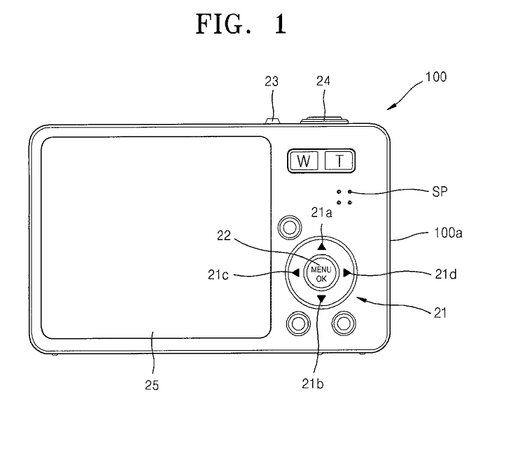

FIG. 1 is a rear view of a digital camera 100 which is an example of a digital image processing apparatus according to the present invention. Referring to FIG. 1, the back side of the digital camera 100 may include a four-way button 21, a menu-OK button 22, a wide-angle zoom button W, a telephoto-zoom button T, a speaker SP, and a display panel 25.

The four-way button 21 may include a total of four buttons, namely, an upward button 21a, a downward button 21b, a leftward button 21c, and a rightward button 21d. The four-way button 21 and the menu-OK button 22 are keys for executing various menu items associated with an operation of a digital image processing apparatus such as a digital camera.

The wide-angle zoom button W or the telephoto-zoom button T is used to widen or narrow a viewing angle. In particular, the wide-angle zoom button W or the telephoto-zoom button T may be used to change the size of a selected exposed area. When the wide-angle zoom button W is pressed, the size of the selected exposed area may increase. When the telephoto-zoom button T is pressed, the size of the selected exposed area may decrease.

A zoom magnification may be controlled by a user's manipulation of the wide-angle zoom button W or the telephoto-zoom button T.

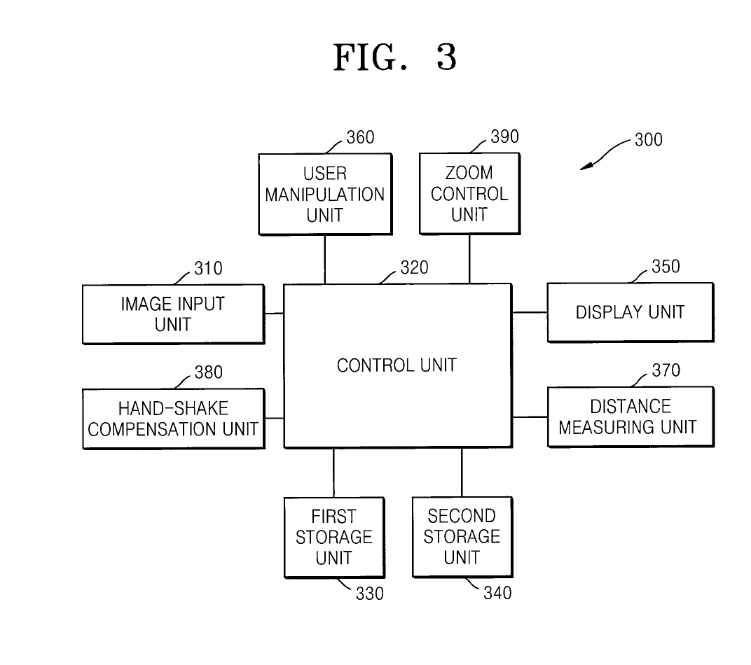

An image display device such as a liquid crystal display (LCD) or the like may be used as the display panel 25. The display panel 25 may be implemented as a touch screen through which the user's manipulations can be made. The display panel 25 may be included in a display unit 350 (see FIG. 3) on which an input image is displayed in live view or a stored image is reproduced and displayed.

A power switch 23, a shutter release button 24, a flash (not shown), and a lens unit (not shown) may be included on a front side or an upper side of the digital camera 100.

The four-way button 21, the menu-OK button 22, the power switch 23, and the shutter release button 24 may be included in a user manipulation unit 360 (see FIG. 3) through which a user inputs commands.

The power switch 23 may be used to turn on or off the digital camera 100. The shutter is opened and closed by manipulating the shutter release button 24 to expose a film or an imaging device such as a charge coupled device (CCD) to light for a predetermined period of time. The shutter release button 24 operates in conjunction with an aperture (not shown) so as to control exposure, thereby imprinting images on the imaging device.

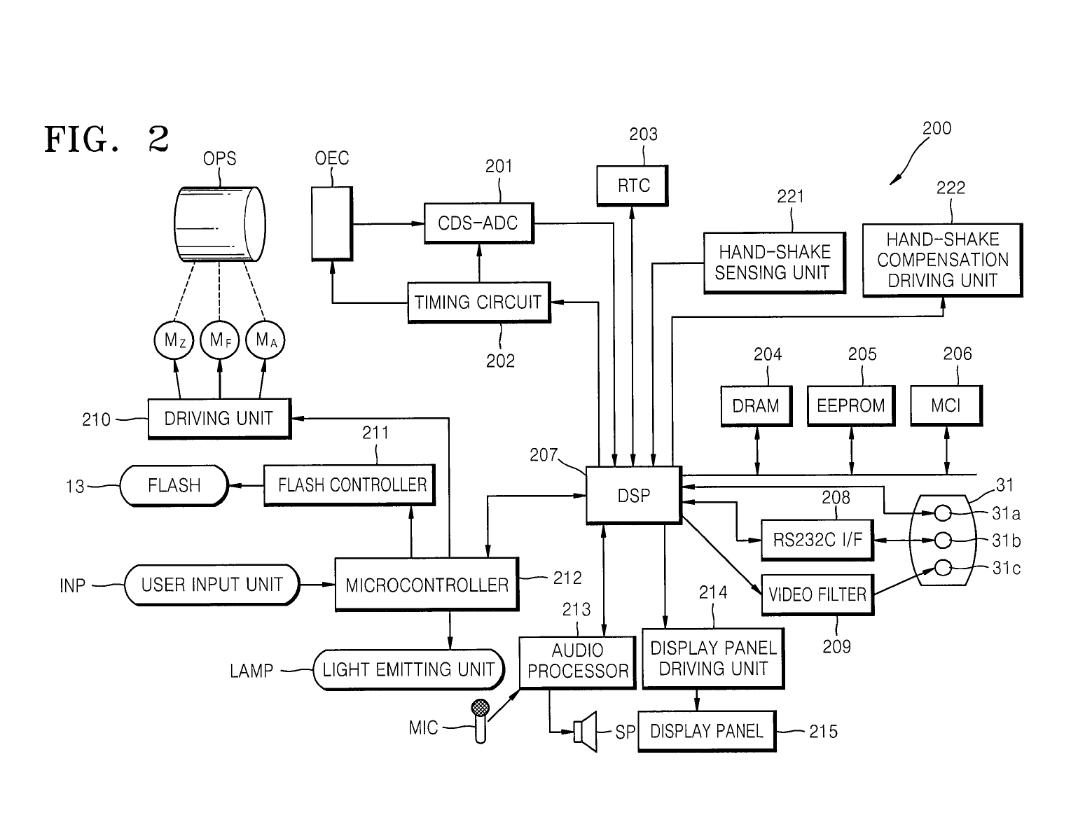

A camera body 100a of the digital camera 100 may include a hand-shake sensor which senses a shake of the camera body 100a. The hand-shake sensor may include an acceleration sensor and/or an angular rate sensor, and may be included in a hand-shake sensing unit 221 of FIG. 2.

The degree of measured shake may be the direction and distance in which the camera body 100a is moved or the distance and angle in which the camera body 100a is rotated by the shake. A hand-shake compensation driving unit 222 of FIG. 2 may be driven to move or rotate the lens unit or the imaging device so as to compensate for the measured shake.

A digital camera, which is an example of a digital image processing apparatus to which the present invention can be applied, and an apparatus and a method of controlling the digital camera are disclosed in U.S. Patent Publication No. 2004/0130650, assigned to the applicant of the present application and entitled “Method of automatically focusing using a quadratic function in camera”.

Matters related to the digital camera and the apparatus and method of controlling the digital camera, which are disclosed in U.S. Patent Publication No. 2004/0130650, are included in the specification of the present application, and a detailed description thereof will be omitted.

FIG. 2 is a block diagram schematically illustrating a controlling apparatus 200 of a digital image processing apparatus, according to an embodiment of the present invention. The controlling apparatus 200 may be installed in the digital camera 100 of FIG. 1.

Referring to FIG. 2, an optical system OPS including a lens unit and a filter unit optically processes light from a subject. The lens unit of the optical system OPS includes a zooming lens, a focusing lens, and a compensation lens. When a user presses the wide-angle zoom button W or the telephoto-zoom button T included in a user input unit INP, a corresponding signal is input to a microcontroller 212.

Accordingly, as the microcontroller 212 controls a driving unit 210, a zooming motor M_{Z} is operated to move the zooming lens. In other words, when the wide-angle zoom button W is pressed, a focal distance of the zooming lens decreases and thus a viewing angle is widened, and when the telephoto-zoom button T is pressed, the focal distance of the zooming lens increases and thus the viewing angle is narrowed.

A zoom control unit 390 of FIG. 3 may include the zooming motor M_{Z} and the driving unit 210 and accordingly may move the location of the zooming lens along an optical axis, thereby controlling a zoom magnification in which an input image is received.

In an auto focusing mode, a main controller installed in a digital signal processor (DSP) 207 controls the driving unit 210 via the microcontroller 212, and thus a focusing motor M_{F} is driven. In other words, the focusing motor M_{F} is driven to move the focusing lens to a location capable of giving the clearest picture.

In this case, the focusing motor M_{F} and the driving unit 210 may constitute a focusing driving unit which moves the focusing lens. The focusing lens and the focusing driving unit may be included in a distance measuring unit 370 of FIG. 3, which is used in distance measurement according to an embodiment of the present invention.

The compensation lens compensates for the overall refractive index, and thus the compensation lens is not separately driven. The reference character M_{A} indicates an aperture controlling motor for driving an aperture (not shown).

In the filter unit of the optical system OPS, an optical low pass filter (OLPF) removes optical noise having high frequency components. An infra-red cut filter (IR-cut filter) blocks infrared components of incident light.

A photoelectric converter OEC may be constructed by including the imaging device such as a CCD or a complementary metal-oxide-semiconductor (CMOS). The photoelectric converter OEC converts light from the optical system OPS into an electrical analog signal.

An analog-to-digital converter (ADC) may be constructed by including a correlation double sampler and ADC (CDS-ADC) 201. The ADC processes the analog signal received from the photoelectric converter OEC so as to remove high-frequency noise and control the amplitude of the analog signal, and then converts the analog signal into a digital signal. The DSP 207 controls a timing circuit 202 to control operations of the photoelectric converter OEC and the CDS-ADC 201.

The optical system OPS, the photoelectric converter OEC, and the CDS-ADC 201 may be included in an image input unit 310 of FIG. 3.

A real time clock (RTC) 203 provides time information to the DSP 207. The DSP 207 processes the digital signal received from the CDS-ADC 201 so as to generate a digital image signal divided into a luminance signal Y and chrominance signals R, G, and B.

A light emitting unit LAMP operated by the micro-controller 212 according to the control of the main controller embedded in the DSP 207 may include a self-timer lamp, an automatic focus lamp, a mode indicating lamp, and a flash standby lamp.

The user input unit INP may include the four-way button 21, the menu-OK button 22, the wide-angle zoom button W, and the telephoto-zoom button T. The user input unit INP may be included in the user manipulation unit 360 of FIG. 3.

The digital image signal from the DSP 207 is temporarily stored in a dynamic random access memory (DRAM) 204. Algorithms needed in the operation of the DSP 207, such as a booting program and a key input program, and setting data are stored in an electrically erasable and programmable read-only memory (EEPROM) 205. A memory card of a user may be inserted into or removed from a memory card interface (MCI) 206.

The DSP 207 and/or the microcontroller 212 may be included in a control unit 320 of FIG. 3 according to an embodiment of the present invention. A cache memory, which acts as a temporary storage space, may be installed in the DSP 207 and/or the microcontroller 212.

In this case, the cache memory and the DRAM 204 may be included in a first storage unit 330 of FIG. 3 in which a zoom magnification, a subject distance, a hand-shake degree, and an input image are temporarily stored. The cache memory included in the first storage unit 330 of FIG. 3 may be separate from the DSP 207 and/or the microcontroller 212.

The memory card which is recognized via the MCI 206 stores captured images in a non-volatile manner, and may be included in a second storage unit 340 of FIG. 3.

The digital image signal output from the DSP 207 is input to a display panel driving unit 214. As a result, an image is displayed on the display panel 215.

The controlling apparatus 200 of the digital image processing apparatus may further include display units, for example, the display panel driving unit 214 and the display panel 215. The display panel 215 and the display panel driving unit 214 may be included in a display unit 350 of FIG. 3.

The digital image signal output from the DSP 207 may be transmitted as a serial communication via a universal serial bus (USB) connector 31a or via an RS232C interface 208 and its connector 31b. Alternatively, the digital image signal output from the DSP 207 may be transmitted as a video signal via a video filter 209 and a video outputting unit 31c. Here, a micro-controller may be embedded in the DSP 207.

An audio processor 213 outputs an audio signal from a microphone MIC to the DSP 207 or a speaker SP, and outputs an audio signal from the DSP 207 to the speaker SP.

The controlling apparatus 200 for the digital image processing apparatus may include a hand-shake sensing unit 221 and a hand-shake compensation driving unit 222. The hand-shake sensing unit 221 and the hand-shake compensation driving unit 222 may be included in a hand-shake compensation unit 380 of FIG. 3.

The hand-shake sensing unit 221 may sense hand-shake that causes the camera body 100a to shake. The hand-shake compensation driving unit 222 may be driven according to the sensed hand-shake and thus compensate for the sensed hand-shake. The hand-shake sensing unit 221 may include an acceleration sensor and/or an angular rate sensor.

The acceleration sensor may sense a change in speed, which is caused by a movement of the camera body 100a. The angular rate sensor may sense a change in angular rate, which is caused by a movement of the camera body 100a. A gyro sensor may be used as the angular rate sensor.

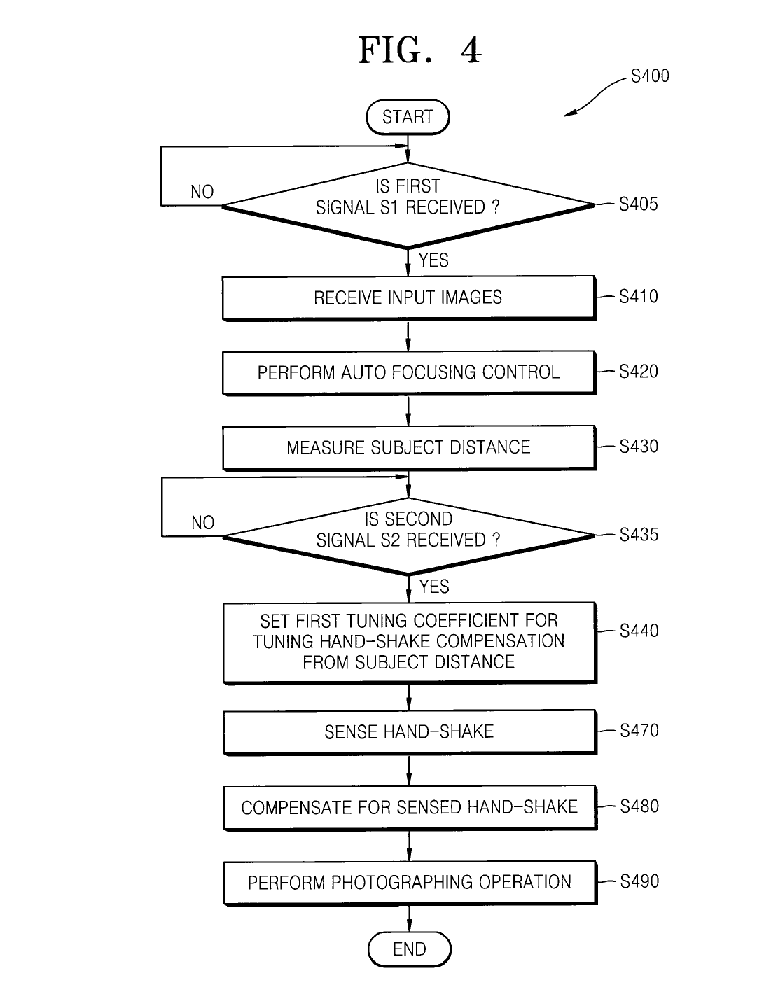

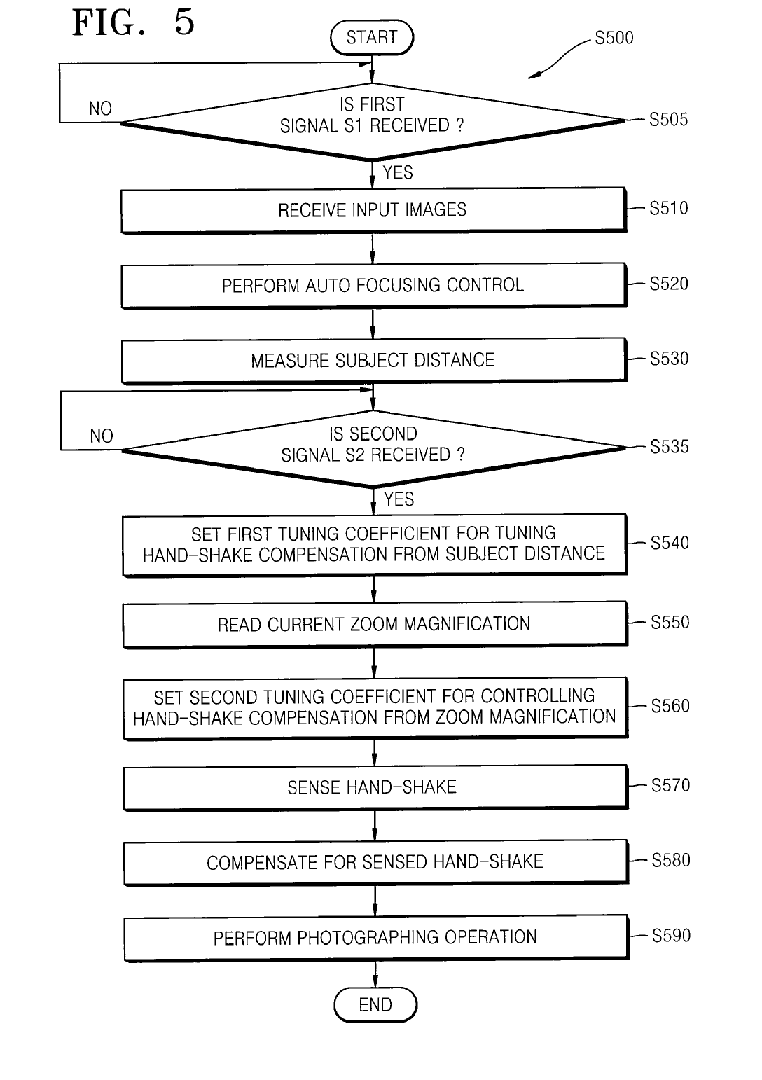

FIG. 3 is a block diagram schematically illustrating a digital image processing apparatus 300 according to an embodiment of the present invention. The digital image processing apparatus 300 may be controlled according to digital image processing apparatus controlling methods S400 and S500 illustrated in FIGS. 4 and 5. Thus, features of the digital image processing apparatus 300 that are the same as those of the digital image processing apparatus controlling methods S400 and S500 described later with reference to FIGS. 4 and 5 will not be described here.

Referring to FIG. 3, the digital image processing apparatus 300 may include the image input unit 310, the control unit 320, the first and second storage units 330 and 340, the display unit 350, the user manipulation unit 360, the distance measuring unit 370, the hand-shake compensation unit 380, and the zoom control unit 390.

The distance measuring unit 370 may measure a subject distance corresponding to a distance between the body of the digital image processing apparatus 300 and a subject to be photographed. The hand-shake compensation unit 380 may compensate for hand-shake that causes the body of the digital image processing apparatus 300 to shake.

The control unit 320 may set a first tuning coefficient for tuning hand-shake compensation according to the subject distance and control the hand-shake compensation unit 380 to compensate for the hand-shake by incorporating the first tuning coefficient.

The first tuning coefficient may be set so that a compensation amount for compensating for the hand-shake increases in proportion to the subject distance.

The effect of the hand-shake of a photographer may vary according to the subject distance between the body of the digital image processing apparatus 300 and the subject. The effect of the hand-shake of a photographer increases as the subject distance increases. The effect of the hand-shake of a photographer may also vary according to the set zoom magnification. The effect of the hand-shake of a photographer increases as the set zoom magnification increases.

Accordingly, the digital image processing apparatus 300 may differently compensate for hand-shake depending on the subject distance and the zoom magnification.

The distance measuring unit 370 may measure the subject distance by automatic focusing control. To achieve this, the distance measuring unit 370 may include a focusing lens and a focusing driving unit. The focusing motor M_{F} and the driving unit 210 illustrated in FIG. 2 may be included in the focusing driving unit which operates to move the focusing lens.

However, the distance measuring unit 370 is not limited thereto, and the distance measuring unit 370 may measure the subject distance according to various other methods, such as, by using a distance measuring sensor.

The focusing lens moves at predetermined intervals and receives input images at locations where the focusing lens is positioned when moving at the predetermined intervals. The focusing driving unit moves the focusing lens. At this time, the control unit 320 may determine the location of the focusing lens at which the clearest image from among the input images is received, to be a focus location, and measure, as the subject distance, a distance corresponding to the focus location.

The zoom control unit 390 may include a zooming lens and a zooming driving unit. The zooming driving unit may include the zooming motor M_{Z} and the driving unit 210 of FIG. 2, and may control a zoom magnification in which input images are received by moving the zooming lens along an optical axis.

At this time, the control unit 320 may set a second tuning coefficient for controlling hand-shake compensation according to the zoom magnification. The second tuning coefficient may be set so that a compensation amount, for compensating for the hand-shake, increases in proportion to the zoom magnification.

The hand-shake compensation unit 380 may include the hand-shake sensing unit 221 and the hand-shake compensation driving unit 222 illustrated in FIG. 2. The hand-shake sensing unit 221 may sense the hand-shake that causes the body of the digital image processing apparatus 300 to shake. The hand-shake compensation driving unit 222 may be driven according to the sensed hand-shake and thus, compensate for the sensed hand-shake.

The control unit 320 may control the hand-shake compensation unit 380 to compensate for the hand-shake by incorporating the first and/or second tuning coefficients.

The image input unit 310 receives external input images. The received input images may be live view images that are received and displayed in real time. The image input unit 310 may include the optical system OPS, the photoelectric converter OEC, and the CDS-ADC 201 which are illustrated in FIG. 2.

The control unit 320 may control the image input unit 310, the first and second storage units 330 and 340, the display unit 350, the user manipulation unit 360, the distance measuring unit 370, the hand-shake compensation unit 380, and the zoom control unit 390 to compensate for hand-shake by reflecting the subject distance.

The control unit 320 may include the DSP 207 and/or the microcontroller 212 which are illustrated in FIG. 2.

The first and second storage units 330 and 340 may store the zoom magnification, the subject distance, a degree of hand-shake, the input images, and captured images. The first storage unit 330 may temporarily store the zoom magnification, the subject distance, the degree of hand-shake, and the input images. The second storage unit 340 may store the captured images.

The display unit 350 may include the display panel 25 of FIG. 1 and/or the display panel driving unit 214 and the display panel 215 of FIG. 2. The display unit 350 may be implemented as a touch screen so as to be able to directly receive a user's manipulations.

The user may input desired external commands via the user manipulation unit 360. The user manipulation unit 360 may include the four-way button 21 and the menu-OK button 22 of FIG. 1 and/or the user input unit INP of FIG. 2.

In a digital image processing apparatus and a method of controlling the same, the distance between the digital image processing apparatus and a subject to be photographed or a current zoom magnification is measured, and hand-shake compensation is performed taking into account the measured distance or the measured zoom magnification, thereby improving hand-shake compensation performance.

FIG. 4 is a flowchart of the digital image processing apparatus controlling method S400 according to an embodiment of the present invention.

The digital image processing apparatus controlling method S400 may be performed in the digital image processing apparatus 300 of FIG. 3 and/or the controlling apparatus 200 of FIG. 2. To achieve this, the digital image processing apparatus controlling method S400 may be a program or an algorithm that is stored in a storage unit of FIG. 2 or implemented in the form of a semiconductor chip such as firmware.

Accordingly, features of the digital image processing apparatus controlling method S400 which are the same as those of the digital image processing apparatus 300 and the controlling apparatus 200 described above with reference to FIGS. 3 and 2 will not be described here in detail.

Referring to FIG. 4, the digital image processing apparatus controlling method S400 may include operations S410 through S430 for measuring a subject distance, a subject distance reflecting operation S440, a hand-shake sensing operation S470, and a hand-shake compensating operation S480.

In operations S410 through S430 for measuring a subject distance, a subject distance corresponding to a distance between the body of a digital image processing apparatus and a subject to be photographed is measured. In the subject distance reflecting operation S440, a first tuning coefficient for tuning hand-shake compensation according to the subject distance is set.

In the hand-shake sensing operation S470, hand-shake that causes the body to shake is sensed. In the hand-shake compensating operation S480, the hand-shake is compensated for by incorporating the first tuning coefficient for tuning hand-shake compensation.

An influence of the hand-shake of a photographer may vary according to the subject distance between the body of the digital image processing apparatus and the subject. The influence of the hand-shake of a photographer increases as the subject distance increases. In other words, when the degree of hand-shake affecting a subject close to the digital image processing apparatus is compared with the degree of hand-shake affecting a subject far from the digital image processing apparatus, an image of a subject far from the digital image processing apparatus may be more greatly affected by hand-shake than an image of a subject close to the digital image processing apparatus.

Accordingly, in the digital image processing apparatus controlling method S400, the subject distance between the body and the subject may be measured, and the amount of hand-shake compensation may be determined by incorporating the measured subject distance.

In the operations S410 through S430 for measuring a subject distance, the subject distance corresponding to the distance between the body of a digital image processing apparatus and a subject to be photographed may be measured by automatic focusing control. To achieve this, the subject distance may be measured by performing an input image receiving operation S410, a focus location determining operation S420, and a subject distance selecting operation S430.

In the input image receiving operation S410, while a focusing lens is moved at predetermined intervals, input images are received at locations where the focusing lens is positioned. In the focus location determining operation S420, the location of the focusing lens at which the clearest image from among the input images is received is determined to be the focus location. In the subject distance selecting operation S430, a distance corresponding to the focus location is selected as the subject distance, thereby measuring the subject distance.

However, the present invention is not limited thereto, and the subject distance may be measured according to various other methods, such as, by using a distance measuring sensor.

The operations S410 through S430 for measuring a subject distance may be performed when a first signal S1 is received. In other words, when the first signal S1 is received in operation S405, the input image receiving operation S410, the focus location determining operation S420, and the subject distance selecting operation S430 may be performed.

In the subject distance reflecting operation S440, the first tuning coefficient for tuning hand-shake compensation according to the subject distance is set. The first tuning coefficient may be set so that a compensation amount for compensating for the hand-shake increases in proportion to the subject distance. The amount of movement of a lens unit or an imaging device made for hand-shake compensation may be compensated by the first tuning coefficient for tuning hand-shake compensation.

In the hand-shake sensing operation S470, hand-shake that causes the body to shake is sensed. In the hand-shake compensating operation S480, the sensed hand-shake is compensated for according to the sensed hand-shake. More specifically, the hand-shake may be compensated for by moving the lens unit or the imaging device, which receives images, in a hand-shake compensation direction and a hand-shake compensation distance which are determined according to the sensed hand-shake.

In the hand-shake compensating operation S480, the hand-shake may be compensated for in consideration of the first tuning coefficient for tuning hand-shake compensation. Accordingly, the hand-shake may be compensated for in consideration of the subject distance. This results in improvement of hand-shake compensation performance.

The subject distance reflecting operation S440, the hand-shake sensing operation S470, and the hand-shake compensating operation S480 may be performed when a second signal S2 corresponding to a photographing initiation signal is received. In other words, when it is determined in operation S435 that the second signal S2 is received, the subject distance reflecting operation S440, the hand-shake sensing operation S470, and the hand-shake compensating operation S480 may be performed before a photographing operation is performed in operation S490.

In the digital image processing apparatus controlling method S400 according to the present embodiment, a distance between the digital image processing apparatus and a subject to be photographed is measured, and hand-shake compensation is performed in consideration of the measured distance, thereby improving hand-shake compensation performance.

FIG. 5 is a flowchart of an image processing apparatus controlling method S500 according to another embodiment of the present invention. The digital image processing apparatus controlling method S500 is different from the digital image processing apparatus controlling method S400 in that hand-shake compensation is performed in consideration of not only a subject distance but also a current zoom magnification. Accordingly, technical features of the digital image processing apparatus controlling method S500, which are similar to the digital image processing apparatus controlling method S400, are indicated by similar reference numerals, and a detailed description thereof will be omitted here.

Referring to FIG. 5, the digital image processing apparatus controlling method S500 may include operations S510 through S530 for measuring a subject distance, a subject distance reflecting operation S540, a zoom magnification reading operation S550, a zoom magnification reflecting operation S560, a hand-shake sensing operation S570, and a hand-shake compensating operation S580.

In operations S510 through S530 for measuring a subject distance, a subject distance corresponding to a distance between the body of the digital image processing apparatus and a subject to be photographed is measured. In the subject distance reflecting operation S540, a first tuning coefficient for tuning hand-shake compensation taking into account the subject distance is set.

In the hand-shake sensing operation S570, hand-shake that causes the body to shake is sensed. In the hand-shake compensating operation S580, the hand-shake is compensated for in consideration of the first tuning coefficient for tuning hand-shake compensation.

In the operations S510 through S530 for measuring a subject distance, the subject distance corresponding to the distance between the body of a digital image processing apparatus and a subject to be photographed may be measured by automatic focusing control. The subject distance may be measured by performing an input image receiving operation S510, a focus location determining operation S520, and a subject distance selecting operation S530.

However, the present invention is not limited thereto, and the subject distance may be measured according to various other methods, such as, by using a distance measuring sensor.

An influence of the hand-shake of a photographer may vary according to a set zoom magnification. The influence of the hand-shake of a photographer increases as the zoom magnification increases. Accordingly, the digital image processing apparatus controlling method S500 may compensate for hand-shake according to the zoom magnification.

In other words, the current zoom magnification may be read out, and a hand-shake compensation amount may be determined by incorporating, taking into account, the read current zoom magnification. To achieve this, a second tuning coefficient may be set according to the zoom magnification, and hand-shake may be compensated for by incorporating the second tuning coefficient.

To compensate for a hand-shake that reflects the zoom magnification, the digital image processing apparatus controlling method S500 may include a zoom magnification reading operation S550 and a zoom magnification reflecting operation S560. In the zoom magnification reading operation S550, the current zoom magnification is read out. In the zoom magnification reflecting operation S560, the second tuning coefficient for controlling hand-shake compensation according to the zoom magnification is set.

In this case, in the hand-shake compensating operation S580, the hand-shake may be compensated for by incorporating the second tuning coefficient. The second tuning coefficient may be set so that a compensation amount for compensating for the hand-shake increases in proportion to the zoom magnification.

Since the hand-shake may be compensated for by incorporating the second tuning coefficient in the hand-shake compensating operation S580, the hand-shake may be compensated for by incorporating the zoom magnification. Accordingly, hand-shake compensation performance may be improved.

When the hand-shake is compensated for in the hand-shake compensating operation S580, the first and second tuning coefficients for tuning hand-shake compensation may be reflected. Accordingly, the hand-shake may be compensated for by incorporating the subject distance and the zoom magnification. This may result in improvement of hand-shake compensation performance.

When it is determined in operation S505 that the first signal S1 is received, the input image receiving operation S510, the focus location determining operation S520, and the subject distance selecting operation S530 may be performed.

When it is determined in operation S535 that the second signal S2 is received, the subject distance reflecting operation S540, the zoom magnification reading operation S550, the zoom magnification reflecting operation S560, the hand-shake sensing operation S570, and the hand-shake compensating operation S580 may be performed before a photographing operation is performed in operation S590.

In a digital image processing apparatus and a method of controlling the same, a distance between the digital image processing apparatus and a subject to be photographed or a current zoom magnification is measured, and hand-shake compensation is performed taking into consideration the measured distance or the measured zoom magnification, thereby improving hand-shake compensation performance.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

Numerous modifications and adaptations will be readily apparent to those skilled in this art without departing from the spirit and scope of the present invention.

What is claimed is:

1. A method of controlling a digital image processing apparatus, the method comprising:
measuring a subject distance corresponding to a distance between a body of the digital image processing apparatus and a subject to be photographed;
setting a first tuning coefficient for tuning hand-shake compensation according to the subject distance;
sensing hand-shake that causes the body to shake; and
compensating for the hand-shake by incorporating the first tuning coefficient.

2. The method of claim 1, wherein the subject distance is measured by automatic focusing control.

3. The method of claim 2, wherein the measuring of the subject distance comprises:
receiving input images at locations of a focusing lens obtained by moving the focusing lens at predetermined intervals;
determining a location of the focusing lens, at which the clearest image from among the input images is received, to be a focus location; and
measuring a distance corresponding to the focus location as the subject distance.

4. The method of claim 1, wherein the first tuning coefficient is set so that a compensation amount for compensating for the hand-shake increases in proportion to the subject distance.

5. The method of claim 1, further comprising:
reading a current zoom magnification; and
setting a second tuning coefficient for controlling hand-shake compensation according to the current zoom magnification.

6. The method of claim 5, wherein in the compensating of the hand-shake, the hand-shake is compensated for by incorporating the first and second tuning coefficients.

7. The method of claim 5, wherein the second tuning coefficient is set so that a compensation amount for compensating for the hand-shake increases in proportion to the zoom magnification.

8. A digital image processing apparatus comprising:
a distance measuring unit measuring a subject distance corresponding to a distance between a body of the digital image processing apparatus and a subject to be photographed;
a hand-shake compensation unit compensating for hand-shake that causes the body to shake; and
a control unit setting a first tuning coefficient for tuning hand-shake compensation according to the subject distance and controlling the hand-shake compensation unit to compensate for the hand-shake by incorporating the first tuning coefficient.

9. The digital image processing apparatus of claim 8, wherein the distance measuring unit measures the subject distance by automatic focusing control.

10. The digital image processing apparatus of claim 8, wherein the distance measuring unit comprises:
a focusing lens receiving input images at locations of the focusing lens obtained by moving the focusing lens at predetermined intervals; and
a focusing driving unit driving the focusing lens to move.

11. The digital image processing apparatus of claim 10, wherein the control unit determines a location of the focusing lens, at which the clearest image from among the input images is received, to be a focus location, and measures a distance corresponding to the focus location as the subject distance.

12. The digital image processing apparatus of claim 8, wherein the first tuning coefficient is set so that a compensation amount for compensating for the hand-shake increases in proportion to the subject distance.

13. The digital image processing apparatus of claim 8, wherein the hand-shake compensation unit comprises:
a hand-shake sensing unit sensing hand-shake that causes the body to shake; and
a hand-shake compensation driving unit being driven in response to the sensed hand-shake and compensating for the hand-shake.

14. The digital image processing apparatus of claim 8, further comprising a zoom control unit controlling a zoom magnification.

15. The digital image processing apparatus of claim 14, wherein the control unit sets a second tuning coefficient for controlling hand-shake compensation according to the zoom magnification and controlling the hand-shake compensation unit to compensate for the hand-shake by incorporating the first and second tuning coefficients.

16. The digital image processing apparatus of claim 15, wherein the second tuning coefficient is set so that a compensation amount for compensating for the hand-shake increases in proportion to the zoom magnification.

17. The digital image processing apparatus of claim 8, wherein the distance measuring unit measures the subject distance by a distance measuring sensor.

18. The digital image processing apparatus of claim 8, further comprising a storage unit for storing the measured subject distance.

19. The digital image processing apparatus of claim 18, wherein the storage unit stores a degree of hand-shake.

20. A method of controlling a digital image processing apparatus, the method comprising:
measuring a subject distance corresponding to a distance between a body of the digital image processing apparatus and a subject to be photographed;
setting a first tuning coefficient for tuning hand-shake compensation according to the subject distance;
sensing hand-shake that causes the body to shake;
compensating for the hand-shake by incorporating the first tuning coefficient;
reading a current zoom magnification;
setting a second tuning coefficient for controlling hand-shake compensation according to the current zoom magnification; and
photographing the subject.
